(19) United States
(12) Patent Application Publication
(10) Pub. No.: US 2026/0117794 A1
(43) Pub. Date: Apr. 30, 2026

(54) Slidable Liners in Fan Exit Guide Vane Structure

(71) Applicant: RTX Corporation, Farmington, CT (US)

(72) Inventors: Murat YAZICI, Glastonbury, CT (US); Andrew E. BREAULT, Bolton, CT (US); Jeffrey T. MORTON, Manchester, CT (US)

(73) Assignee: RTX Corporation, Farmington, CT (US)

(21) Appl. No.: 18/933,287

(22) Filed: Oct. 31, 2024

(51) Int. Cl. F04D 29/54; F04D 29/66

(52) U.S. Cl. CPC F04D 29/541; F04D 29/664; F05D 2220/32; F05D 2240/123; F05D 2260/96

(57) ABSTRACT

A fan exit guide vane with acoustic treatment including a leading edge and a trailing edge opposite chordwise from the leading edge; a radially inner attachment region opposite spanwise from a radially outer attachment region; a span dimension extending between the radially inner attachment region and the radially outer attachment region; a chord dimension extending between the leading edge and the trailing edge; a pressure side opposite a suction side of the fan exit guide vane; an acoustic panel receiver formed within the fan exit guide vane extending at least one of spanwise through the fan exit guide vane between the radially inner attachment region and the radially outer attachment region or chordwise between the leading edge and the trailing edge; and an acoustic panel inserted into the acoustic panel receiver.

### BACKGROUND

The present disclosure is directed to the improved interchangeable acoustic strips and panels for fan exit guide vane structure.

Current gas turbine engine design, as seen in FIG. 1 through FIG. 4a, includes a design with variable or non-variable fan exit guide vanes (FEGV). The fan F is positioned within the fan duct FD proximate the engine inlet EI. The fan exit guide vanes (FEGV) are downstream from the fan F and located forward of the bypass duct BD.

A current FEGV pattern is created to minimize airflow back pressure adverse effect on fan blades F caused by the downstream presence of nacelle N bypass duct BD elements (FIG. 2), such as the upper and lower bifurcation (BiFi), air-to-oil cooler (AOC), and environmental control system inlet (ECS).

As seen in FIG. 3, the FEGV has a circumferential pattern CP made up of vanes V that can translate the structural load path LP shown as arrows in FIG. 4. All vane types are designed with the same cross sectional monolithic load carrying features (FIG. 4a). Additionally, the FEGV pattern aims to optimize the fan duct performance and acoustic characteristics of the gas turbine engine.

The FEGV pattern is defined to meet structural, performance and acoustic requirements across a wide range of operating conditions. It is therefore not optimized at any single mission condition, like cruise condition or climb condition. Engine noise targets are getting more challenging for future programs. Engine and airframe makers are looking for more opportunities for noise reduction. At the engine side, acoustic treatable areas are limited. Fan exit guide vanes are an area for noise reduction opportunities.

### SUMMARY

In accordance with the present disclosure, there is provided a fan exit guide vane with acoustic treatment comprising a leading edge and a trailing edge opposite chordwise from the leading edge; a radially inner attachment region opposite spanwise from a radially outer attachment region; a span dimension extending between the radially inner attachment region and the radially outer attachment region; a chord dimension extending between the leading edge and the trailing edge; a pressure side opposite a suction side of the fan exit guide vane; an acoustic panel receiver formed within the fan exit guide vane extendable at least one of spanwise through the fan exit guide vane between the radially inner attachment region and the radially outer attachment region or chordwise between the leading edge and the trailing edge; and an acoustic panel inserted into the acoustic panel receiver.

A further embodiment of any of the foregoing embodiments may additionally and/or alternatively include the acoustic panel receiver is one of at least two acoustic panel receivers one of at least two acoustic panel receivers formed in the fan exit guide vane at predetermined locations along the span of the fan exit guide vane.

A further embodiment of any of the foregoing embodiments may additionally and/or alternatively include the acoustic panel receiver is located on the pressure side.

A further embodiment of any of the foregoing embodiments may additionally and/or alternatively include the acoustic panel receiver comprises at least one of a rectangular cross section, an oval cross section, a tee shaped cross section.

A further embodiment of any of the foregoing embodiments may additionally and/or alternatively include the fan exit guide vane with acoustic treatment further comprising the acoustic treatment formed within the acoustic panel, the acoustic treatment configured to dissipate sound energy.

A further embodiment of any of the foregoing embodiments may additionally and/or alternatively include the acoustic panel is configured slidable into the acoustic panel receiver.

A further embodiment of any of the foregoing embodiments may additionally and/or alternatively include the acoustic panel is configured interchangeable to accommodate design changes and/or damage to the acoustic panel.

In accordance with the present disclosure, there is provided a gas turbine engine with a fan exit guide vane with acoustic treatment comprising a fan located within a fan duct; an array of fan exit guide vanes supported within the fan duct downstream from the fan, the array of fan exit guide vanes span across the fan duct attached to a radially inner surface of the fan duct and a radially outer surface of the fan duct; a leading edge and a trailing edge opposite chordwise from the leading edge; a radially inner attachment region opposite spanwise from a radially outer attachment region; a span dimension extending between the radially inner attachment region and the radially outer attachment region; a chord dimension extending between the leading edge and the trailing edge; a pressure side opposite a suction side of the fan exit guide vane; an acoustic panel receiver formed within the fan exit guide vane extendable at least one of spanwise through the fan exit guide vane between the radially inner attachment region and the radially outer attachment region or chordwise between the leading edge and the trailing edge; and an acoustic panel inserted into the acoustic panel receiver.

A further embodiment of any of the foregoing embodiments may additionally and/or alternatively include the acoustic panel receiver is one of at least two acoustic panel receivers formed in the fan exit guide vane at predetermined locations along the span of the fan exit guide vane.

A further embodiment of any of the foregoing embodiments may additionally and/or alternatively include the gas turbine engine with a fan exit guide vane with acoustic treatment further comprising the acoustic treatment formed within the acoustic panel, the acoustic treatment configured to dissipate sound energy.

A further embodiment of any of the foregoing embodiments may additionally and/or alternatively include the acoustic panel receiver is located on the pressure side of the fan exit guide vane.

A further embodiment of any of the foregoing embodiments may additionally and/or alternatively include the acoustic panel receiver comprises at least one of a rectangular cross section, an oval cross section, a tee shaped cross section.

A further embodiment of any of the foregoing embodiments may additionally and/or alternatively include the acoustic panel is slidable into the acoustic panel receiver.

In accordance with the present disclosure, there is provided a process for a fan exit guide vane with acoustic treatment comprising locating a fan within a fan duct; supporting an array of fan exit guide vanes within the fan duct downstream from the fan; attaching the array of fan exit guide vanes spanned across the fan duct to a radially inner surface of the fan duct and a radially outer surface of the fan duct; coupling a radially inner attachment region of each fan exit guide vane of the array of fan exit guide vanes in operative communication with the radially inner surface of the fan duct; coupling a radially outer attachment region of each fan exit guide vane of the array of fan exit guide vanes in operative communication with the radially outer surface of the fan duct; forming an acoustic panel receiver within each fan exit guide vane extending at least one of spanwise through the fan exit guide vane between the radially inner attachment region and the radially outer attachment region or chordwise between a leading edge and a trailing edge of each fan exit guide vane; and inserting an acoustic panel into the acoustic panel receiver.

A further embodiment of any of the foregoing embodiments may additionally and/or alternatively include the process further comprising forming the acoustic panel receiver in each of the fan exit guide vanes at predetermined locations along a span of the fan exit guide vanes.

A further embodiment of any of the foregoing embodiments may additionally and/or alternatively include the process further comprising forming the acoustic treatment within the acoustic panel; and configuring the acoustic treatment to dissipate sound energy.

A further embodiment of any of the foregoing embodiments may additionally and/or alternatively include the process further comprising locating the acoustic panel receiver on the pressure side of each fan exit guide vane.

A further embodiment of any of the foregoing embodiments may additionally and/or alternatively include the process further comprising configuring the acoustic panel slidable into the acoustic panel receiver.

A further embodiment of any of the foregoing embodiments may additionally and/or alternatively include the process further comprising configuring the acoustic panel interchangeable to accommodate design changes and/or damage to the acoustic panel.

A further embodiment of any of the foregoing embodiments may additionally and/or alternatively include the process further comprising shaping the acoustic panel to influence acoustic dampening capability in the proximity of the fan exit guide vane.

Other details of the interchangeable acoustic strips and panels for fan exit guide vane structure are set forth in the following detailed description and the accompanying drawings wherein like reference numerals depict like elements.

### BRIEF DESCRIPTION OF THE DRAWINGS

FIG. 1 is a schematic representation of a prior art gas turbine engine.

FIG. 2 is a schematic representation of a prior art gas turbine engine.

FIG. 3 is a schematic representation of a prior art fan exit guide vane pattern.

FIG. 4 is a schematic representation of a prior art fan exit guide vane with load path.

FIG. 4A is a sectional view schematic representation of the prior art fan exit guide vane FIG. 4.

FIG. 5 is a schematic representation of an exemplary fan exit guide vane with acoustic treatment.

FIG. 5a is a sectional view of schematic representation of the exemplary fan exit guide vane with acoustic treatment.

FIG. 6 is a schematic representation of exemplary fan guide exit vanes with acoustic treatment.

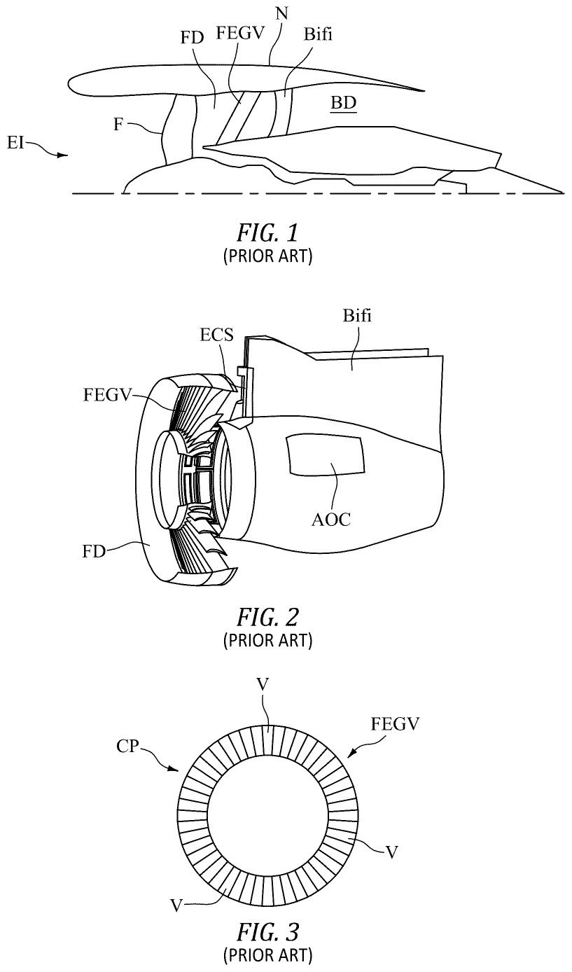

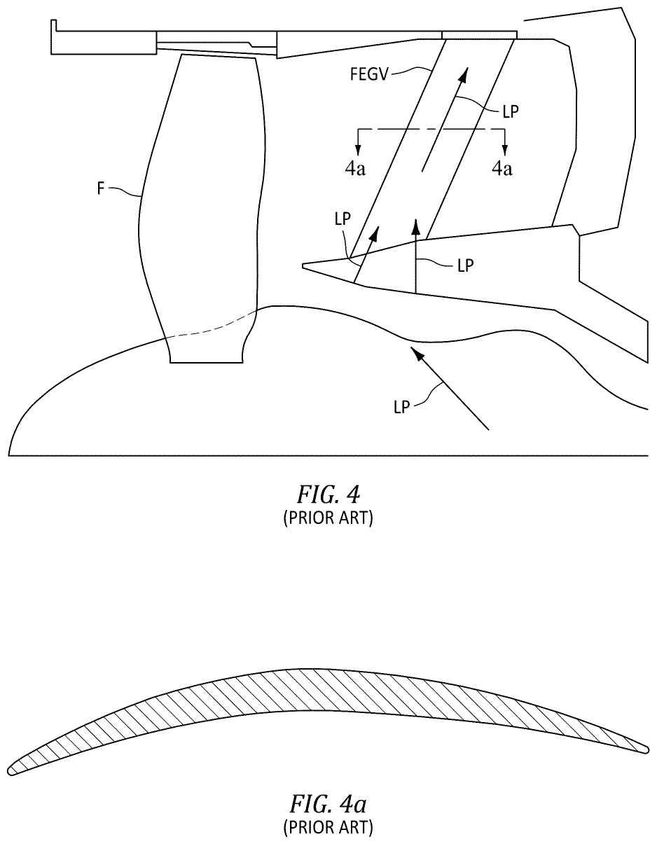

### DETAILED DESCRIPTION

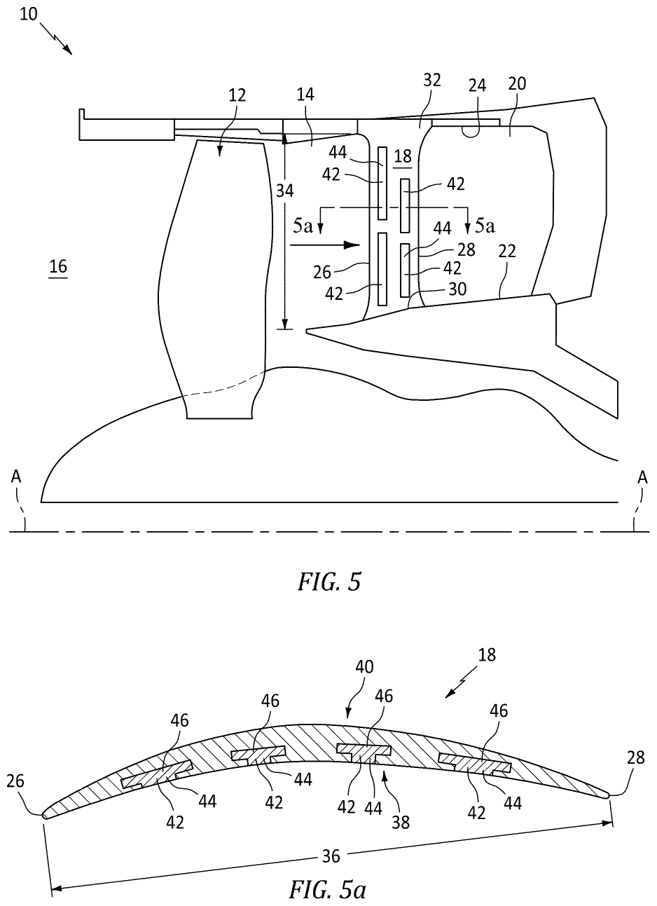

Referring now to FIG. 5 showing a schematic of a gas turbine engine 10. The gas turbine engine 10 includes a fan 12 with fan blades within a fan duct 14 proximate an engine inlet 16. Downstream from the fan 12 is a fan exit guide vane 18 upstream from a bypass duct 20.

The fan exit guide vane 18 spans across the fan duct 14 attached to a radially inner surface 22 of the fan duct 14 and a radially outer surface 24 of the fan duct 14.

With reference also to FIG. 5a, the fan exit guide vane 18 includes a leading edge 26 and a trailing edge 28 opposite chordwise from the leading edge 26.

The fan exit guide vane 18 includes a radially inner attachment region 30 proximate the radially inner surface 22. The fan exit guide vane 18 includes a radially outer attachment region 32 proximate the radially outer surface 24. The radially inner attachment region 30 is opposite spanwise from the radially outer attachment region 32. The radially inner attachment region 30 of the fan exit guide vane 18 attaches to the fan duct 14 at the radially inner surface 22. The radially outer attachment region 32 of the fan exit guide vane 18 attaches to the fan duct 14 at the radially outer surface 24.

The fan exit guide vane 18 includes a span 34 dimension extending between the radially inner attachment region 30 and the radially outer attachment region 32. The fan exit guide vane 18 includes a chord dimension 36 extending between the leading edge 26 and the trailing edge 28, as seen in FIG. 5a. The fan exit guide vane 18 includes a pressure side 38 opposite a suction side 40.

The fan exit guide vane 18 shown in FIG. 5 is oriented generally vertical, that is along a similar radial span between the radially inner surface 22 and radially outer surface 24 relative to the axis A. Alternatively, the fan exit guide vane 18 can include a canted orientation. In an exemplary embodiment, the vane stacking axis can be canted aft, that is the radially inner attachment region is forward of the radially outer attachment region 32.

The fan exit guide vane 18 can include an acoustic treatment 42. The acoustic treatment 42 can be any material or structure configured to dissipate sound energy. The acoustic treatment 42 can include various materials and/or structures with sound-absorbing and diffusing properties. In an exemplary embodiment the acoustic treatment 42 can provide a broadband noise benefit from about 0.5 to 2 EPNdB. The acoustic treatment 42 can be varied from one fan exit guide vane 18 to another. The variation can be by varying the materials, the shape, and the location of the acoustic treatment 42, as further described as follows.

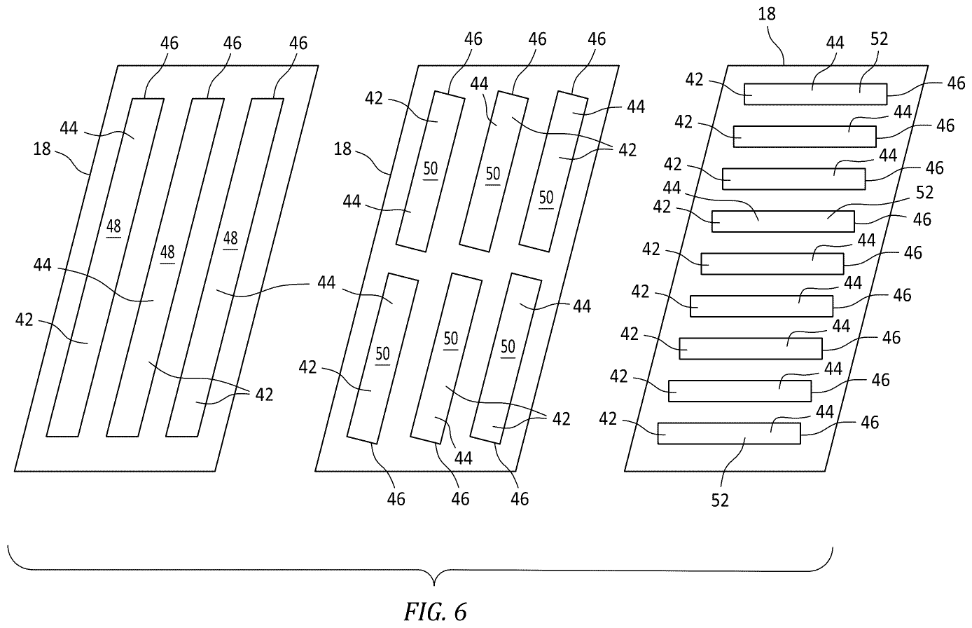

The acoustic treatment 42 can be formed as acoustic panels 44 having cross section shape configured to be inserted into acoustic panel receivers 46 as seen in cross section at FIG. 5a. The acoustic panel receiver 46 can have a cross sectional shape that allows for securing the acoustic panel 44 as well as allowing for insertion of the acoustic panel 44 into the acoustic panel receiver 46. The acoustic panel receiver 46 can have a rectangular cross section, oval cross section, tee shaped cross section, and/or the like. The acoustic panel receivers 46 can be formed in the fan exit guide vane 18 at predetermined locations along the span 34 of the fan exit guide vane 18 as seen in FIG. 6. The acoustic panel receiver 46 can be aligned along the span 34 as long sections 48 and/or short sections 50. The acoustic panel receiver 46 can be aligned chordwise as chord sections 52, as seen in FIG. 6. The terms long section 48 and short section 50 are defined relative to the dimensions of the fan exit guide vane 18, such as long section 48 being more than half the span dimension 34 and short section 50 being less than half the span dimension 34. The chord section 52 dimension is relative to the chord dimension 36 and can vary depending on the fan exit guide vane 18. Though illustrated as being of similar orientations on a single vane 18, this is not intending to be so limiting and a single vane 18 may include one or more long sections 48, one or more short sections 50 and/or one or more chord sections 52.

The acoustic panel 44 can be configured to be inserted into the acoustic panel receivers 46. The acoustic panel 44 is configured to be slidable and insertable as a snap fit or friction fit into the acoustic panel receiver 46. The slidable nature is configured so that the panel 44 would slide in from one end of the receiver 46 (during fabrication of the fan exit guide vane 18) and would be trapped by the geometry of the receiver 46. The acoustic panel 44 can be installed into the acoustic panel receiver 46 from the radially inner attachment region 30, and/or radially outer attachment region 32, leading edge 26 and/or trailing edge 28 and/or mid-span and the like. The parent material of the fan exit guide vane 18 between the receivers 46 can form ribs that provide structure. The orientation (axial vs radial) of these structural features and how they layout will be influenced by the loading characteristics of the specific design of the fan exit guide vane 18. The locations of the acoustic panel receivers 46 can be located dependent on the design of the fan exit guide vane 18 final count/aero design, acoustic and attachment structural requirements.

The acoustic panel 44 can be interchangeable to accommodate design changes and/or damage to the acoustic panel 44. The acoustic panel 44 can be shaped to influence the acoustic capability in the proximity of the fan exit guide vane 18. The acoustic panel 44 can be varied from one fan exit guide vane 18 to another. The variation can be by varying the materials, the shape and the location of the acoustic panel 44. The material, shape, and location of the acoustic panels 44 may also vary between fan exit guide vanes 18.

A technical advantage of the disclosed interchangeable acoustic strips and panels for fan exit guide vane structure includes a capacity to dampen acoustic noise along the surfaces of fan exit guide vanes.

Another technical advantage of the disclosed interchangeable acoustic strips and panels for fan exit guide vane structure includes structural features formed in the fan exit guide vanes configured to receive acoustic panels.

Another technical advantage of the disclosed interchangeable acoustic strips and panels for fan exit guide vane structure includes interchangeable panels with acoustic treatment.

Another technical advantage of the disclosed interchangeable acoustic strips and panels for fan exit guide vane structure includes patterns of acoustic panels attached to fan exit guide vanes enabling both aero and structural function.

There has been provided an interchangeable acoustic strips and panels for fan exit guide vane structure. While the interchangeable acoustic strips and panels for fan exit guide vane structure has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A fan exit guide vane with acoustic treatment comprising:
a leading edge and a trailing edge opposite chordwise from the leading edge; a radially inner attachment region opposite spanwise from a radially outer attachment region; a span dimension extending between the radially inner attachment region and the radially outer attachment region; a chord dimension extending between the leading edge and the trailing edge; a pressure side opposite a suction side of the fan exit guide vane;
an acoustic panel receiver formed within the fan exit guide vane extendable at least one of spanwise through the fan exit guide vane between the radially inner attachment region and the radially outer attachment region or chordwise between the leading edge and the trailing edge; and
an acoustic panel inserted into the acoustic panel receiver.

2. The fan exit guide vane with acoustic treatment according to claim 1, wherein the acoustic panel receiver is one of at least two acoustic panel receivers formed in the fan exit guide vane at predetermined locations along the span of the fan exit guide vane.

3. The fan exit guide vane with acoustic treatment according to claim 1, wherein the acoustic panel receiver is located on the pressure side.

4. The fan exit guide vane with acoustic treatment according to claim 1, wherein the acoustic panel receiver comprises at least one of a rectangular cross section, an oval cross section or a tee shaped cross section.

5. The fan exit guide vane with acoustic treatment according to claim 1, further comprising:
the acoustic treatment formed within the acoustic panel, the acoustic treatment configured to dissipate sound energy.

6. The fan exit guide vane with acoustic treatment according to claim 1, wherein the acoustic panel is configured slidable into the acoustic panel receiver.

7. The fan exit guide vane with acoustic treatment according to claim 1, wherein the acoustic panel is configured interchangeable to accommodate design changes and/or damage to the acoustic panel.

8. A fan exit guide vane system with acoustic treatment for a gas turbine engine, the FEGV system comprising:
a fan located within a fan duct; and
an array of fan exit guide vanes supported within the fan duct downstream from the fan, the array of fan exit guide vanes span across the fan duct attached to a radially inner surface of the fan duct and a radially outer surface of the fan duct;
wherein each fan exit guide vane of the array of fan exit guide vanes comprises:
a leading edge and a trailing edge opposite chordwise from the leading edge; a radially inner attachment region opposite spanwise from a radially outer attachment region;
a span dimension extending between the radially inner attachment region and the radially outer attachment region;
a chord dimension extending between the leading edge and the trailing edge; a pressure side opposite a suction side of the fan exit guide vane;
an acoustic panel receiver formed within the fan exit guide vane extendable at least one of spanwise through the fan exit guide vane between the radially inner attachment region and the radially outer attachment region or chordwise between the leading edge and the trailing edge; and
an acoustic panel inserted into the acoustic panel receiver.

9. The fan exit guide vane system with acoustic treatment for a gas turbine engine according to claim 8, wherein the acoustic panel receiver is one of at least two acoustic panel receivers formed in the fan exit guide vane at predetermined locations along the span of the fan exit guide vane.

10. The fan exit guide vane system with acoustic treatment for a gas turbine engine according to claim 8, further comprising:
the acoustic treatment formed within the acoustic panel, the acoustic treatment configured to dissipate sound energy.

11. The fan exit guide vane system with acoustic treatment for a gas turbine engine according to claim 8, wherein the acoustic panel receiver is located on the pressure side of the fan exit guide vane.

12. The fan exit guide vane system with acoustic treatment for a gas turbine engine according to claim 8, wherein the acoustic panel receiver comprises at least one of a rectangular cross section, an oval cross section or a tee shaped cross section.

13. The fan exit guide vane system with acoustic treatment for a gas turbine engine according to claim 8, wherein the acoustic panel is slidable into the acoustic panel receiver.

14. A process for a fan exit guide vane with acoustic treatment comprising:
locating a fan within a fan duct;
supporting an array of fan exit guide vanes within the fan duct downstream from the fan;
attaching the array of fan exit guide vanes spanned across the fan duct to a radially inner surface of the fan duct and a radially outer surface of the fan duct;
coupling a radially inner attachment region of each fan exit guide vane of the array of fan exit guide vanes in operative communication with the radially inner surface of the fan duct;
coupling a radially outer attachment region of each fan exit guide vane of the array of fan exit guide vanes in operative communication with the radially outer surface of the fan duct;
forming an acoustic panel receiver within each fan exit guide vane extending at least one of spanwise through the fan exit guide vane between the radially inner attachment region and the radially outer attachment region or chordwise between a leading edge and a trailing edge of each fan exit guide vane; and
inserting an acoustic panel into the acoustic panel receiver.

15. The process of claim 14, further comprising:
forming the acoustic panel receiver in each of the fan exit guide vanes at predetermined locations along a span of the fan exit guide vanes.

16. The process of claim 14, further comprising:
forming the acoustic treatment within the acoustic panel; and
configuring the acoustic treatment to dissipate sound energy.

17. The process of claim 14, further comprising:
locating the acoustic panel receiver on the pressure side of each fan exit guide vane.

18. The process of claim 14, further comprising:
configuring the acoustic panel slidable into the acoustic panel receiver.

19. The process of claim 14, further comprising:
configuring the acoustic panel interchangeable to accommodate design changes and/or damage to the acoustic panel.

20. The process of claim 14, further comprising:
shaping the acoustic panel to influence acoustic dampening capability in the proximity of the fan exit guide vane.
